(19) United States
(12) Patent Application Publication
(10) Pub. No.: US 2008/0044159 A1
(43) Pub. Date: Feb. 21, 2008

(54) DVD enhanced with audio CD content

(76) Inventors: Eric Vandewater, Scottsdale, AZ (US); Arthur M. Ripp, Los Angeles, CA (US)

Correspondence Address: Michal Avniel, 668 N. 44th St., Ste 248, Phoenix, AZ, 85008, US

(21) Appl. No.: 11/507,228

(22) Filed: Aug. 21, 2006

(51) Int. Cl. H04N 7/00

(52) U.S. Cl. 386/96

(57) ABSTRACT

A DVD contains a first digital work comprising a DVD-video, a second digital work comprising one or more audio CD tracks and one or more software programs that enable access of the DVD-video and the second digital work to a personal computer. The CD tracks can be downloaded to a CD. In a preferred embodiment the second digital work contains digital information that when downloaded onto a CD produces an enhanced CD which is copy protected.

### FIELD OF THE INVENTION

The present invention relates to a DVD that contains digital information corresponding to an audio CD within the DVD file structure. The audio CD digital information can be downloaded onto a PC hard drive or onto a CD for personal use. The digital content of the CD is preferably copy protected.

### BACKGROUND OF THE INVENTION

The movie and music industries expend large amounts of resources in producing and marketing feature films and audio CDs. In recent years it has been very popular to produce a movie soundtrack on an audio CD and sell that soundtrack concurrently with the release of a feature movie or soon thereafter. Also, in recent years, many of the record label companies have been bought out by movie production companies. Because the production, marketing, and distribution costs are separate for CDs and DVDs, the record labels and movie production companies have tried to reduce their overhead and increase margins by distributing soundtrack CDs that are included in a feature movie DVD retail package. Some companies have made and distributed single sided DVD discs that have an audio CD adhered to the back side of the single sided DVD resulting in a rather thick disc that is a DVD on one side and an audio CD on the other (Dual Disc). The audio CD is usually the soundtrack. CD that accompanies the feature movie on the DVD side of the disc. Problems with those products and marketing schemes is that they still incur the cost of producing an audio CD. Additionally, the two sided discs having one side a CD and the other side a DVD are not playable on all CD players.

The widespread use of personal computers and Internet access has permitted extensive unauthorized digital extraction, reproduction, and distribution of a significant amount of artistic content, including audio, video, software; images, and text. Significant contributing factors to this unauthorized distribution include the large volume of digital content that has been made available to consumers in formats such as audio CD, CD-ROM, CD-R, DVD, and DVD-R media and the ease of digital extraction and duplication of the music or other content on these physical media. Unfortunately, the standards used to produce the content for audio CDs (e.g., the IEC 60908 Redbook Standard) were not originally intended to prevent transfer of the content in digital or analog form and do not use methods to conceal the digital data on the CD for preventing unauthorized transfer. Further, copies made using digital processes are of high quality. Even copies using compressed formats such as, for example the standard MPEG Audio Layer 3 (MP3) format or Microsoft's Window® Media (WMA) format, are of good quality in comparison to prior analog copying approaches.

The music industry in particular has a strong interest in protecting its proprietary works from unauthorized copying and distribution, especially over the Internet or through other computer-based copying and distribution using music ripping software or other techniques. A number of attempts have been made by the music industry to provide music CDs that can be reliably played in consumer CD players but that somehow are resistant to digital audio extraction by a personal computer. Although there has been some success in this area, anything less than 100 percent playability by the wide array of consumer CD players that are already in use is extremely undesirable. This applies to the two sided DVD/CD discs referred to above. When a consumer purchases a new CD he or she expects it to play in his or her equipment, and there is a great amount of anger and frustration if it does not. The record industry is extremely reluctant to take the risk of this happening to its end consumers who appropriately purchase its music offerings. A disadvantage of some prior copy protection technologies is that they prevent a consumer who has legitimately purchased a compact disc from playing music files from the compact disc using his or her computer. Many consumers who purchase music on compact discs expect to be able to play them on their computers, or at least to extract the music to their hard drives using software that contains a digital rights management protocol, such as Windows Media Player®.

Copy protection technologies typically use a CD layout where a first session (Session 1) contains Redbook compliant audio tracks only and a second session (Session 2) contains exactly one single data track for computer use. Such a format is compliant with the Enhanced CD format as specified in the Sony/Philips Blue Book standard. Media player software is designed to recognize either a single session disc with audio only or a multi-session disc with the layout described above.

There are basically two ways to copy protect digital content on an optical disc such as a digital audio compact disc. One way is generally referred to as passive protection and involves modifying the data structures on the discs that are inconsistent or incompatible with the published standards such as the Redbook standard for audio CDs. These modifications involve changes in essential control data stored on the disc, such as the Lead-In, Lead-Out, Table Of Contents (TOC), and sub-channels. These modifications appear as errors, and can prevent copying in many PC configurations, but a serious drawback is that these modifications also prevent some CD players from playing the CDs. The music industry and consumers of music have a zero tolerance with respect to incompatibility with CD players. In other words, any copy protection system must be able to play the protected CD in all CD players, i.e., home stereos, boom boxes, portable personal CD players, car CD players, video game systems, and the like.

The second way to copy protect a CD is typically referred to as active protection. The concept is to incorporate software onto the CD that is downloaded to a computer when the CD is inserted into the computer drive. The software downloaded onto the PC then regulates what can and cannot be done with the protected digital content on the CD. When a copy protected CD with active protection is inserted into a PC many operating systems, such as Windows, have autorun features that automatically start software programs present on the CD. The software programs downloaded from the CD allow only permitted and authorized uses of the digital content on the CD. For example, copy protection software can prohibit extraction of the CD-DA tracks by ripping software, but allow the burning of a limited number of CD copies for personal use employing digital rights management (DRM) technologies and allowing for the downloading of DRM protected music files onto the PC for playing on the PC via media player software.

A downside of active protection is the dependency on software that needs to be installed on the computer before the protection will be effective. Active protection is typically delivered from the CD. If installation of the software from the CD is prevented, for instance, by holding down the shift-key on some computer systems, the user may obtain access to the first session Redbook audio files without the protection provided by the copy protection software on the CD.

A need exists for an improved system and method for marketing DVDs and audio CDs which is less costly to produce, does not adversely affect playability and provides consumers an opportunity to play music that they have purchased on their personal computers (PC). A further need exists to allow consumers to copy, for personal use, the audio tracks onto a computer hard drive or a CD which preferably incorporates copy protection functions.

The present invention provides solutions to the above by eliminating the production and associated distribution costs of making an audio CD while providing the digital content for an audio CD in a DVD. The digital content of the audio tracks can conveniently be copied to a computer hard drive or a CD for personal use.

### SUMMARY OF THE INVENTION

Briefly, in accordance with the present invention, a digital video disc (DVD) is made that contains both a DVD-video, a file that contains one or more audio tracks, and a software program that allows access to the DVD-video and the audio track file(s). Preferably, the audio tracks correspond to the soundtrack CD for the video feature film on the DVD. The audio tracks/soundtrack can be played on a computer with a DVD drive after downloading the accessing software from the DVD onto the computer. The file that contains the audio tracks is preferably configured to contain digital information corresponding to a multi-session CD (enhanced CD) wherein the first session contains Redbook compliant audio tracks and a second data session contains software to manage the audio content such as copy protection software. The audio track file present on the DVD can be copied onto a computer hard drive or a CD using a personal computer for the personal use of the purchaser of the original DVD. The copied or burned CD is preferably copy protected.

The present invention also relates to the audio CD made by downloading digital information stored on the DVD. Advantageously, the copied CD is an enhanced CD that contains a first session of one or more audio tracks and a second session containing data. Preferably, the copied CD is compliant with the various international standards set for the manufacture of audio CDs, such as for example, the Redbook, Blue Book, and Yellow Book standards. The burned CD can be played on any audio CD player, a computer, or a DVD player. The software on the second session is preferably automatically downloaded onto the computer when the copied CD is inserted into a CD drive of a personal computer. The downloaded software manages the audio content by performing such functions as playing the audio content, limiting the further copying of the audio content (copy protection), gathering and transmitting marketing and advertising promotional information, allowing the purchaser of the DVD and owner of the burned CD to send copies of selected audio tracks to friends over the internet, and the like.

Additionally, the present invention relates to a method of marketing video and music to consumers by packaging a DVD-video, an audio CD file, and a software program that allows access to the DVD-video and the audio track file onto a digital video disc (DVD) wherein the audio CD content is (a) contained on the DVD in digital form and (b) can be downloaded from the DVD onto a CD using a CD/DVD drive of a personal computer. The downloading of the audio CD content is possible only after the software program on the DVD is downloaded onto the PC. This convenient DVD that contains the digital information of an audio CD is offered for sale providing the consumer with the enjoyment of both the DVD-video and the audio CD capabilities. The audio CD can be played on a PC having a DVD drive. The consumer may also burn a copy of the audio CD file onto a CD for personal use. The burned CD is preferably a Blue Book compliant multi-session CD.

Another aspect of the present invention is a method of making an audio CD for personal use by purchasing a DVD containing one or more files that contain digital information corresponding to an audio CD and downloading such one or more files onto a CD. The downloading of the audio CD file is accomplished with software also contained on the DVD which must be downloaded onto a PC to facilitate the audio CD files to be downloaded. The resulting copied or burned CD is advantageously an enhanced CD that complies with the Blue Book standards and incorporates copy protection.

Of particular interest in practicing the present invention, a DVD is made that contains a first digital work comprising a DVD-video, a second digital work comprising digital information that is the equivalent of an enhanced CD, and a software program that allows access to the first and second digital works. The second digital work contains digital information that corresponds to the digital information necessary to make an enhanced CD which includes a first session and a second session. The first session contains one or more audio tracks. The second session contains one or more computer programs or software that manages the use of the audio tracks contained in the first session. The second digital work can be downloaded onto a CD using a personal computer resulting in an enhanced CD for personal use. The copied CD can be played on any CD player, DVD player and on computer CD drives. Preferably, the enhanced CD is the soundtrack CD of the movie featured on the DVD-video.

### BRIEF DESCRIPTION OF THE DRAWINGS

FIG. 1 is a diagram showing the content of a DVD of the present invention and the use of the DVD in a DVD drive of a personal computer.

FIG. 2 is a diagram showing the burning of an audio CD from a DVD of the present invention.

FIG. 3 is a diagram showing the use of a burned CD of the present invention in a personal computer.

### DETAILED DESCRIPTION OF THE INVENTION

In practicing the present invention a universal disc format DVD is prepared that has two separate digital works and one or more software programs that control access to and from the digital works. The first digital work is a DVD-video such as a feature film or movie which includes the video and soundtrack for the video. The specific content or movie is not critical to the practice of the present invention, as any movie will suffice. In addition to the DVD-video there is a second digital work that contains digital information necessary to produce an audio CD. The third component of the DVD is one or more software programs that allow access of the first and second digital works to a personal computer (PC) after the software program(s) has been downloaded from the DVD onto the PC. Preferably, the digital information contained in the second digital work is sufficient to produce an enhanced CD containing a first session and a second session. The first session contains one or more audio tracks. Preferably, the first session complies with the Redbook standard for audio CDs. The second session is a data session and contains software that controls the use and distribution of the audio content contained in the first session. The particular software present on the second session is not critical to the practice of the present invention and can be any software program that the owner of the digital content deems necessary or desirable to protect and/or promote the artist(s) and the owner of the digital content. For example, the software can limit the number of copies, if any, that can be made. The software can also provide advertising and marketing information including updated advertising information relating to the artist, the record label, or the movie production company, and updated marketing information that can be transmitted to an internet site for the benefit of the parties involved in the production, distribution, and sale of the DVD product of the present invention.

The present DVD which contains an audio CD digital content is sold in commerce. A purchaser of the present DVD can play the DVD to watch the DVD-video in a DVD player or in a DVD drive of a properly equipped PC. The purchaser of the product can also load the present DVD in a CD/DVD drive of a personal computer and download the one or more software programs present on the DVD to get access to the second digital work which resides in a file in the DVD directory. By downloading the software from the DVD to a PC the purchaser can then play the second digital work or download the second digital work onto a CD to make an audio CD. Preferably, the second digital work comprises digital information sufficient to make an enhanced CD.

The DVD of the present invention is made according to well known DVD manufacturing techniques. There are several related standards for DVDs published by the ECMA organization that are in common use today. These standards include:
ECMA-267 (3^{rd} Ed., April 2001) entitled “120 mm DVD—Read-Only Disk”;
ECMA-268 (3^{rd} Ed. April 2001) entitled “80 mm DVD—Read-Only Disk”;
ECMA-272 (2^{nd} Ed., June 1999), entitled “DVD Rewritable Disk (DVD-RAM)”;
ECMA-274 (June 1999), entitled “Data Interchange on 120 mm Optical Disk Using +RW Format—Capacity: 3.0 Gbytes and 6.0 Gbytes”; and
ECMA-279 (December 1998) entitled “80 mm (1.23 Gbytes per side) and 120 mm (3.95 Gbytes per side) DVD Recordable Disk (DVD-R)”
   All of the above standards are incorporated herein by reference. Most of these standards have been adopted by the International Standards Organization as ISO/IEC standards.

The particular type of DVD is also not critical to the practice of the present invention. The present DVD can be a single layer DVD (Type A, Type B) or a dual layer DVD (Type A, Type D). The DVD can be a one sided DVD (Type A, Type C) or a two sided DVD (Type B, Type D). Preferably, the DVD is made in standard universal disc format (UDF) for DVDs.

A file within the DVD contains the second digital work. The second digital work contains digital information corresponding to an audio CD advantageously in compliance with the Redbook standard. The second digital work is placed in a file on the DVD during the DVD production, preferably encrypted.

In a preferred embodiment of the present invention the second digital work contains the digital information necessary to constitute a multi-session CD and preferably an enhanced CD according to the Blue Book standard. The first session of a multi-session CD contains only audio tracks. The other sessions are data sessions and contain a variety of software, encrypted audio files, sales and advertising materials, materials on the artists, music videos, and the like.

The first session is an audio session structured in accordance with a well known standard format such as the Redbook standards (IEC 60908). Any CD made in accordance with the Redbook standards will play on any audio player made to the Redbook standard. The first session contains only audio tracks. At least one additional session is present on the CD that starts with a data track but can be followed by one or more audio and/or data tracks to provide passive copy protection to the resulting CD made from the downloading of the present DVD; The addition of the audio and/or data track to the data session prevents a media player on the computer from recognizing this as a disc that contains audio, and will therefore not play the audio content.

Each session has a lead-in and a lead-out which flank a program area. A session can be an audio session or a data session and is controlled by control data all according to known standards. The Bluebook standard defines an enhanced music CD disc as a multi-session disc with two sessions. The first session is an audio session and the second session is a CD-ROM XA session. A session is an area on a disc starting with a Lead-In (LI) area, followed by a program area, and ending with a Lead-Out (LO) area. The program area of a session contains tracks which are contiguous areas on the disc with one and the same track number. A track can be an audio track or a data track. An audio track contains CD audio information according to the Redbook standards. A data track contains sectorized data according to the Yellow Book standard. The Bluebook further defines a data session as a session that has a data track as the first track in the program area, while audio sessions contain only audio tracks in the program area of the audio session. As mentioned above, an enhanced music CD contains a CD-ROM XA session as the second session. A CD-ROM XA session is a session wherein the first track in the program area of the session is a CD-ROM XA track. A CD-ROM XA track is a data track that contains sectors in the Mode 2 Form 1 and/or 2 format according to the CD-ROM XA specification, although other formats can be used if desired.

The specific content of the first audio session is not critical to the practice of the present invention and, of course, can be any desired audio work. Preferably, the content of the first session is the soundtrack CD for the movie featured on the DVD. The specific content of the second data session is not critical to the practice of the present invention either in that it, too, can contain any data such as advertising material; software programs used for copy protection and marketing and advertising management; videos; pictures; lyrics; and the like. See, for example, co-pending applications Ser. No. 10/304,259 titled “System and Method of Protecting Digital Content” and filed on 26 Nov. 2002; Ser. No. 10/412,453 titled “System and Method of Protecting and Promoting Digital Content” filed on 11 Apr. 2003; Ser. No. 10/773,686 titled “System and Method of Protecting Digital Content” filed on 6 Feb. 2004; Ser. No. 10/868,576 titled “System and Method of Promoting Copy-Managed Digital Content” filed on 15 Jun. 2004; and Ser. No. 60/697,159 titled “Bluebook Compliant Passive Protection” filed on 7 Jul. 2005; all of which are incorporated herein by reference.

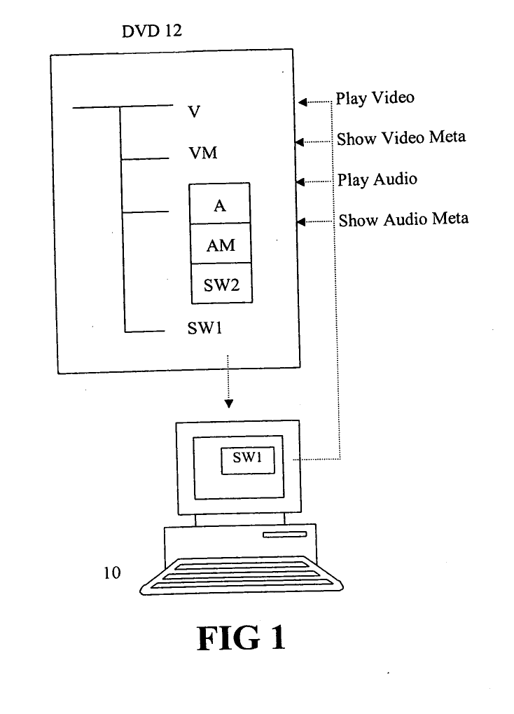

FIG. 1 depicts a DVD of the present invention 12 and the use of said DVD 12 in a personal computer 10. DVD 12 contains a standard DVD-video (V) that is playable in stand alone DVD players. Preferably, the DVD-video is copy protected when used in a personal computer. DVD 12 also contains video metadata (VM), standard audio data (A), audio metadata (AM), audio copy protection software (SW2), and DVD copy protection software (SW1). Video metadata is extra content, preferably stored in encrypted proprietary format. VM is accessible only by DVD copy protection software SW1 after SW1 has been downloaded onto a personal computer 10. When accessed, VM provides an enhanced user experience for the DVD-video. DVD 12 also contains audio related data, namely one or more standard audio tracks (A). The content of A is preferably stored in encrypted format on the DVD and in a standard audio format such as the Redbook standard on the CD. The audio tracks (A) are only accessible by SW1 and/or SW2 after the software has been downloaded onto the PC. Audio metadata (AM) is extra content stored in an encrypted proprietary format and is also accessible only by SW1 and/or SW2 after those software programs have been downloaded to the PC. AM provides an enhanced user experience for the audio content such as advertising, music videos, photographs, lyrics, track sharing with a friend over the internet, and the like. SW1 is software that provides access to the video (V), video metadata (VM), audio (A), and audio metadata (AM) on the DVD through an enhanced user interface. This enables the purchaser of the DVD to burn the audio content (A/AM/SW2) onto a CD and preferably includes copy protection measures. SW2 is software that is associated with the audio content and is automatically downloaded with A and AM when a CD is burned. SW2 provides access to the audio (A) and Audio metadata (AM) on the burned CD through an enhanced user interface and preferably provides copy protection measures. In one embodiment SW1 and SW2 can be substantially the same software.

After SW1 is downloaded onto the personal computer 10, SW1 is used to play back the video (V), audio (A), video metadata (VM), and audio metadata (AM). If the DVD is copy protected, then using SW1 will be the only way to access the DVD-video on the computer. Of course, the DVD will always play the video on a standard DVD player.

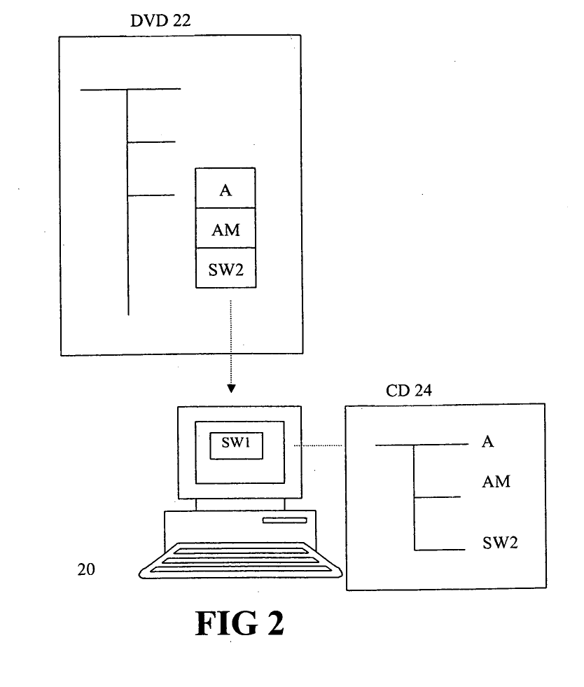

FIG. 2 depicts the burning of a standard enhanced CD 24 from a DVD of the present invention 22 using a personal computer 20. DVD 22 is inserted into the DVD drive and SW1 is downloaded onto the PC 20. Access is then allowed to download A/AM/SW2 onto a CD 24. The resulting enhanced CD 24 is playable on all CD players, and can also be played on a computer as long as SW2 is downloaded onto the computer. SW2 preferably prevents further copying of the audio content on the CD.

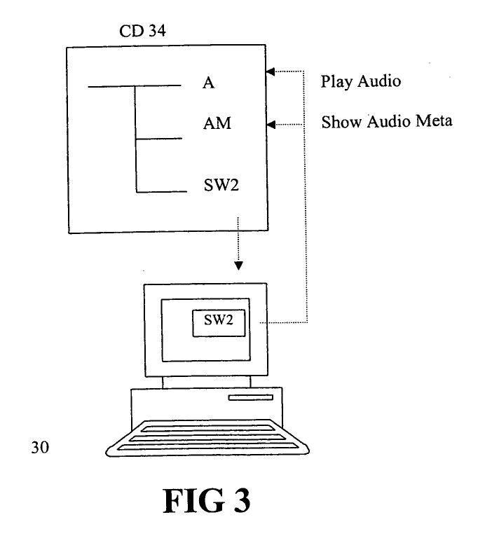

FIG. 3 depicts the burned CD 34 which contains software SW2 and the playing of CD 34 on another computer 30 (other than the computer which w as used to burn CD 34). When CD 34 is inserted into the CD drive of personal computer 30 the software SW2 is downloaded either manually or automatically. SW2 is used to playback the audio (A) and the audio metadata (AM). In a preferred embodiment the CD is copy protected, and using SW2 will be the only means to gain access to the CD audio tracks on the computer. CD 34 is playable on all CD players.

In a preferred embodiment of the present invention the second digital work comprises the digital information corresponding to an enhanced CD disc. This digital information is put into a separate file on the DVD which can be downloaded onto a blank CD using an appropriately configured personal computer. When a CD of the second digital work is burned, the resulting CD is an enhanced CD containing two sessions that comply with the Bluebook standards wherein the first session is an audio session and the second session is a data session that has copy protection software that is automatically downloaded onto the PC by an autorun feature or activated manually by the user. The second session starts out with a data track containing the copy protection software and then is optionally followed by an audio track. The audio track can be any audio track and is preferably a silent audio track of at least 4 seconds; this audio track provides additional copy protection. In operation, this preferred embodiment works as follows when the burned CD is inserted into a PC:

a. if the autorun feature of the PC is enabled, the copy protection software will download onto the PC and control access to and playing of the Redbook audio contained in the first session; or

b. if the autorun feature is disabled, the copy protection software will not download to the computer; the operating system will then recognize the CD as unplayable because of the additional audio track present in the second session; or

c. if the SHIFT key is held down while the CD is being inserted into the PC and the SHIFT key is held down to suspend the running of the autorun feature, then the operating system will recognize the CD as unplayable because of the additional audio track present in the second session.

The above description describes several embodiments of the present invention and should not be construed to limit the scope of the inventions described in the following claims.

We claim:

1. A digital video disc (DVD) which comprises:
a) a first digital work comprising a DVD-video,
b) a second digital work comprising one or more audio CD tracks, and
c) one or more software programs that enable access of the first and second digital works to a personal computer.

2. The DVD of claim 1 wherein the second digital work further comprises one or more data tracks.

3. The DVD of claim 2 wherein the second digital work is digital information that corresponds to an audio CD or a soundtrack CD of the DVD-video.

4. The DVD of claim 2 wherein the audio CD tracks can be played on a personal computer DVD drive after the software (c) is downloaded onto the personal computer.

5. The DVD of claim 2 wherein the second digital work can be copied onto a CD using a personal computer after the software (c) is downloaded onto the personal computer.

6. The DVD of claim 2 wherein the second digital work is in compliance with CD manufacturing standards.

7. The DVD of claim 6 wherein the one or more audio CD tracks are in compliance with Redbook standards.

8. The DVD of claim 7 wherein the second digital work has sufficient digital information to form an enhanced CD when downloaded from the DVD to a CD.

9. An audio CD made by downloading digital information stored on a DVD.

10. The audio CD of claim 9 wherein the CD is an enhanced CD that comprises at least two sessions, wherein a first session contains only audio tracks and a second session contains data.

11. The enhanced CD of claim 10 wherein the second session contains copy protection software that limits the copying and distribution of the digital information on the CD.

12. The audio CD of claim 11 wherein the CD is an enhanced Blue book compliant CD.

13. A method of marketing video and music to consumers which comprises:
(i) packaging a DVD-video, an audio CD for said video, and a software program that allows access to and downloading of said audio CD, onto a digital video disc (DVD); wherein the audio CD (a) is contained on the DVD in digital form and (b) can be downloaded from the DVD onto a CD using the CD/DVD drive of a personal computer after the software program is downloaded onto the personal computer; and
(ii) offering the combination DVD/CD of (i) for sale.

14. The method of claim 13 wherein the audio is Redbook compliant.

15. A method of making a soundtrack CD which comprises:
a) obtaining a DVD that contains a DVD-video, an audio file, and a software program that allows access to and downloading of the audio file, wherein the audio file contains digital information sufficient to make an audio CD:
b) downloading said software program to a personal computer; and
c) downloading the audio file onto a CD using the CD/DVD drive of the personal computer.

16. The method of claim 15 wherein the audio CD is an enhanced CD that contains at least two sessions, wherein a first session contains only audio tracks and a second session contains data.

17. The method of claim 16 wherein the first session is Redbook compliant.

18. The method of claim 17 wherein the second session contains copy protection software that limits the copying and distribution of the digital information on the CD.

19. The method of claim 15 wherein the audio file is in a proprietary format.

20. The method of claim 19 wherein the audio file is encrypted.
